(19) United States
(12) Patent Application Publication
(10) Pub. No.: US 2007/0064434 A1
(43) Pub. Date: Mar. 22, 2007

(54) NAUTICAL LIGHT AND METHODS

(75) Inventors: James Hepworth, Meridian, ID (US); Bryce Adam Hepworth, Boise, ID (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: DBOT5, LLC, Boise, ID (US)

(21) Appl. No.: 11/531,506

(22) Filed: Sep. 13, 2006

Related U.S. Application Data
(60) Provisional application No. 60/717,909, filed on Sep. 16, 2005.

(51) Int. Cl. F21V 33/00

(52) U.S. Cl. 362/477; 362/276

(57) ABSTRACT

Embodiments of the invention provide navigation lights for skiboats and methods of using the same. In a set of embodiments, a navigation light may be configured to cast light in an arc of the horizon in 360 degrees. In accordance with some embodiments, the navigation light thus may be configured to be mounted at or near a top portion of a tow tower. In a set of embodiments, the navigation light may be configured to use battery power. Merely by way of example, in some embodiments, the navigation light may be adapted to hold four AA-size batteries and/or may be configured to operate using the −6VDC provided by such batteries. In other embodiments, the navigation light may be configured to operate using power the boat's electrical system. In yet other embodiments, the navigation light may be configured to use power from both batteries and the boat's electrical system.

### CROSS-REFERENCE TO RELATED APPLICATIONS

This application is a nonprovisional of and claims the benefit of provisional U.S. Application Ser. No. 60/717,909, filed Sep. 16, 2005 by Hepworth et al. and entitled “Nautical Light and Methods,” the entire disclosure of which is hereby incorporated herein by reference for all purposes.

### FIELD OF THE INVENTION

The present invention relates to lighting equipment in general and in particular to lighting equipment for nautical applications.

### BACKGROUND OF THE INVENTION

Waterskiing has long been a favored pastime for many people. Recently, alternative watersports, such as wakeboarding have experienced dramatic gains in popularity. Concurrently, technology for enjoying such watersports has advanced as well. Merely by way of example, many boats used for towing skiers, wakeboarders and others have begun to utilize towers of the type described in U.S. Patent Application Publication No. 2004/0144295 A1 and U.S. Pat. No. 5,979,350, of which the entire disclosure of each is incorporated by reference. These towers are generally regarded as providing an enhanced experience for the skier or wakeboarder.

Most skiboats are less than twelve meters in length. (As used herein, the term “skiboat” is used to refer to any boat that can be used to tow and/or provide a wake for a rider, such as a waterskier, wakeboarder, wakesurfer and/or the like.) U.S. Coast Guard regulations impose specific nautical lighting requirements on such vessels. In particular, a relevant regulation requires an all-round white light, which means “an unbroken light over an arc of the horizon of 360 degrees.” Although most ski boats have navigation lights in appropriate places on exterior of the hull and/or cabin, the presence of a tow tower often means that such navigation lights will not fulfill the all-round lighting requirements, since the tower will obstruct each light when viewed from certain angles. Hence, it becomes necessary to include a navigation light at or near the top of the tow tower in order to comply with the relevant regulations.

Although some boat manufactures have begun to include such lights on towers sold with new boats, many still do not. Moreover, many boat owners wish to retrofit existing boats with tow towers, which often will render the existing lighting on the boat non-compliant. Although after-market navigation lights are available, such lights commonly depend on the boat's −12VDC electrical system for power, rending such lights expensive and difficult to install.

### BRIEF SUMMARY OF THE INVENTION

Embodiments of the invention, therefore, provide navigation lights for ski boats and methods of using the same. In a set of embodiments, a navigation light may be configured to cast light in an arc of the horizon in 360 degrees. In accordance with some embodiments, the navigation light thus may be configured to be mounted at or near a top portion of a tow tower. In a set of embodiments, the navigation light may be configured to use battery power. Merely by way of example, in some embodiments, the navigation light may be adapted to hold four AA-size batteries and/or may be configured to operate using the −6VDC provided by such batteries. In other embodiments, the navigation light may be configured to operate using power the boat's electrical system. In yet other embodiments, the navigation light may be configured to use power from both batteries and the boat's electrical system.

Other embodiments provide methods of using such lights. Merely by way of example, one exemplary method comprises providing a light (such as the light described above, for example), mounting the light at or near a top portion of a tow tower (and/or in a position where the light casts in an arc of the horizon in 360 degrees), and operating the light using power from the boat's electrical system and/or from additional batteries.

### BRIEF DESCRIPTION OF THE DRAWINGS

FIG. 1 is a cutaway perspective drawing of a nautical light in accordance with various embodiments of the invention.

FIG. 2 is an illustration of a nautical light coupled with a tow tower.

FIG. 3 is a circuit diagram illustrating a circuit for powering a nautical light in accordance with embodiments of the invention.

FIG. 4 is a flow chart illustrating a method of using a nautical light in accordance with various embodiments of the invention.

### DETAILED DESCRIPTION OF THE INVENTION

Embodiments of the invention provide navigation lights for ski boats and methods of using the same. In a set of embodiments, a navigation light may be configured to cast light in an arc of the horizon in 360 degrees. In accordance with some embodiments, the navigation light thus may be configured to be mounted at or near a top portion of a tow tower. In a set of embodiments, the navigation light may be configured to use battery power. Merely by way of example, in some embodiments, the navigation light may be adapted to hold four AA-size batteries and/or may be configured to operate using the −6VDC provided by such batteries. In other embodiments, the navigation light may be configured to operate using power the boat's electrical system. In yet other embodiments, the navigation light may be configured to use power from both batteries and the boat's electrical system.

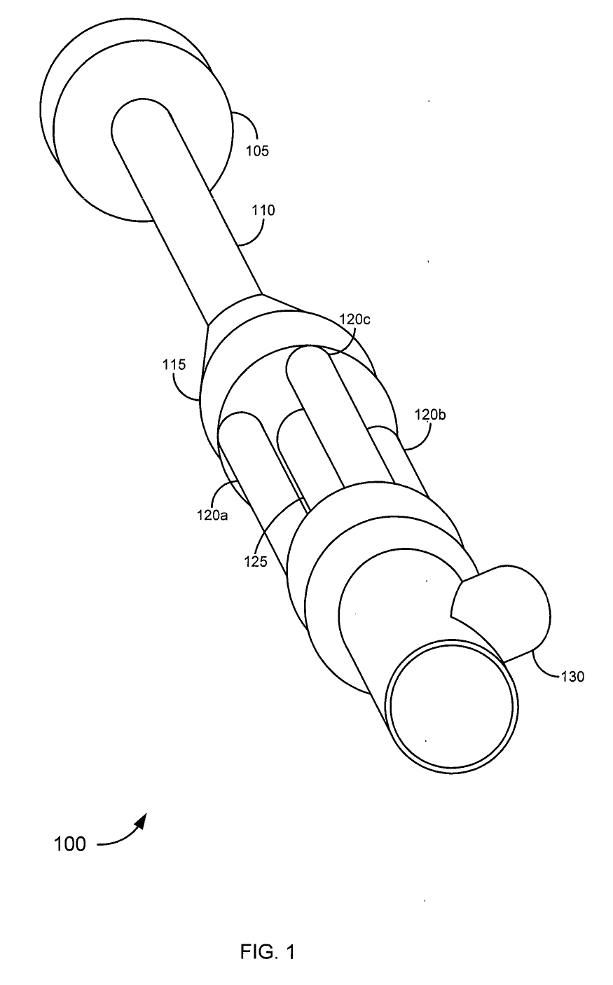

Merely by way of example, FIG. 1 illustrates a nautical light 100 in accordance with one set of embodiments. The nautical light 100 includes a light-emitting member (not shown in FIG. 1), which may be a light bulb, a light emitting diode (“LED”) and/or the like. In some cases, the light-emitting member is disposed within a housing 105 to protect the light-emitting member. The housing 105 optionally is coupled with an extension member 110, which can provide additional height for the light-emitting member from the surface of the water. The extension member 110 (and/or in other cases, the housing 105) is coupled with a body portion 115. In some cases, this coupling can be a removable coupling. Merely by way of example, the body portion 115 and the extension member 110 (and/or housing 105) may have a threaded attachment portion, such that the body portion 115 and the extension member (and/or the housing 105) maybe be threaded together. This can allow for access to the body portion, for example to change batteries.

In accordance with some embodiments, the body portion 115 is adapted to hold one or more batteries.120, which can be used to power the light-emitting member. Merely by way of example, in a set of embodiments, the light-emitting member may be configured to draw power from a −6VDC source, and four −1.5VDC batteries (such as AA-size batteries) can be used to provide this supply voltage.

In certain embodiments, the body portion 115 and/or the extension member 110 may comprise a conduit 125, which can be used to route wiring and/or circuitry to the light-emitting member, from either the batteries 120 and/or an external power source, such as the boat's electrical system.

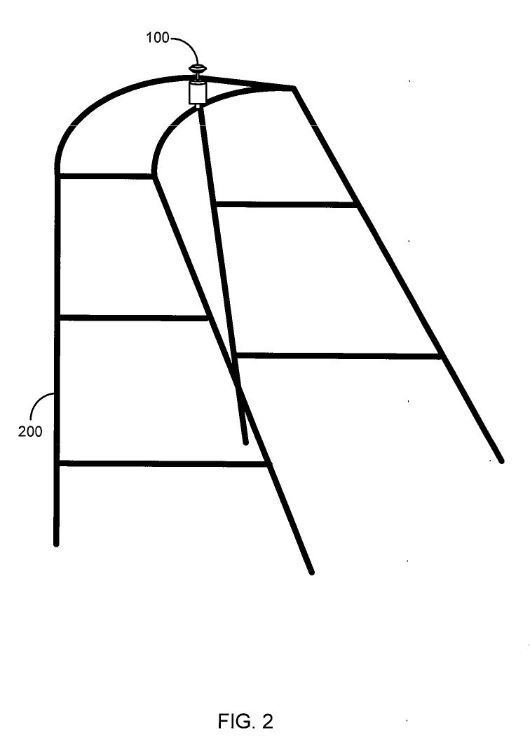

In some cases, and end portion 130 of the body portion may be configured to accept a coupling member (not shown in FIG. 1), such as, to name but one example, the coupling member illustrated and described in commonly-owned, co-pending U.S. application Ser. No. __/______, filed on a date even herewith by Hepworth et al. and entitled “Water Sports Equipment Rack and Methods” (attorney docket no. 026039-000110US), the entire disclosure of which is incorporated herein by reference. Hence, the light 100 may be configured to be mounted on an existing tow tower, accessory tower, and/or any other suitable structure on a boat. Merely by way of example, FIG. 2 illustrates a nautical light 100 mounted on a typical tow tower 200.

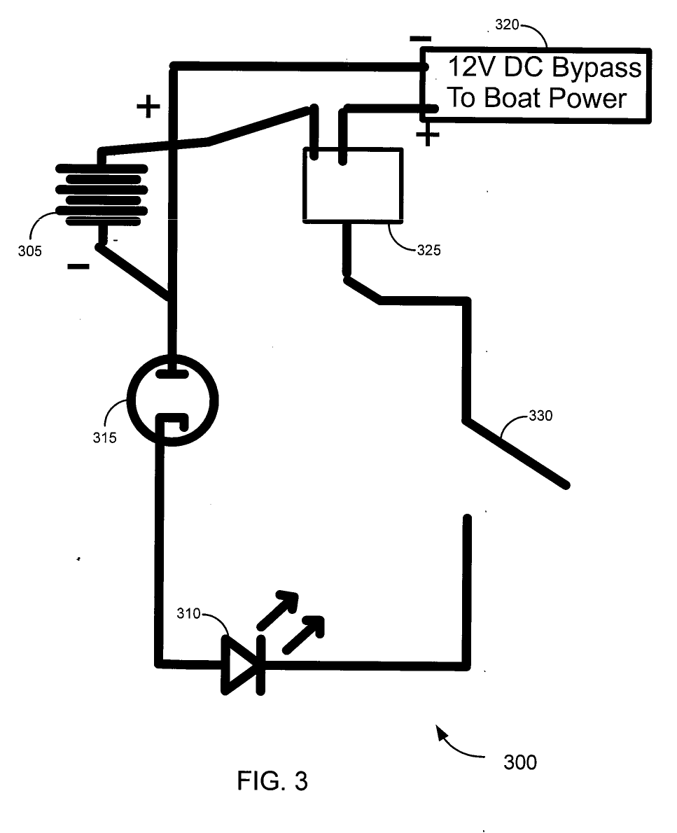

In a set of embodiments, the light 100 may be configured to operate from either the electrical system of a boat, a set of batteries, and/or both. FIG. 3 illustrates a circuit 300 that can allow such operation. The circuit 300 comprises an internal power supply 305, which might be the batteries 120 described above. In electrical communication with the internal power supply 305 is a light-emitting member 310, which, as noted above, might comprise a bulb, an LED, etc.

In certain embodiments, the circuit 300 further comprises a light-sensing device 315, such as a photocell and/or the like, which may be operative to open the circuit 300 when light is sensed, to prevent unnecessary draining of the power source 305. In embodiments where the light 100 is configured to operate on electrical current from a boat's electrical system (or any other external power supply), the circuit may feature a connection 320 to such an external power supply. In such cases, the circuit may also comprise a voltage regulator and/or bypass switch (collectively referenced by numeral 325), both of which are known in the art and commonly available, which might operate to bypass the power supply 305 when external current (e.g., electrical current from the boat's electrical system) is available via the connection 320.

In many embodiments, the circuit 300 also includes a switch 330 (which may be any several types of switches known in the art), which can allow the light 100 to be powered off when not in use.

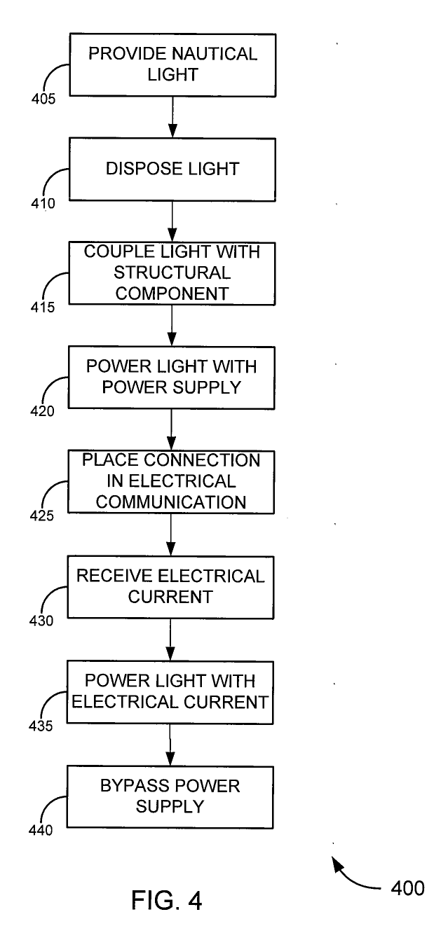

Other embodiments provide methods of using such lights. Merely by way of example, one exemplary method 400 illustrated by FIG. 4 comprises providing a light (such as the light described above, for example) (block 405) and/or disposing the light in a position where the light casts in an arc of the horizon in 360 degrees (such as, for example, mounting the light at or near a top portion of a tow tower, etc.) (block 410). Merely by way of example, the light might be coupled with a structural component of the boat (such as a tow tower, accessory tower, etc.) as described above (block 415).

The method, in some cases, further comprises operating the light using power from the boat's electrical system and/or from additional batteries. Merely by way of example, in some cases, the method comprises powering the light (and/or, more specifically, a light-emitting member of the light) from the power supply 305 and/or batteries 120 (block 420). In other cases, as noted above, the light might include an electrical connection, and the method might comprise placing the electrical connection of the light in electrical communication with an electrical system of the boat (block 425). Hence, method can further comprise receiving electrical current from the boat's electrical system (block 430) and/or powering the light (and/or, more specifically, a light-emitting member thereof) using the electrical current from the boat's electrical system (block 335). As noted above, in some cases, the light might comprise a circuit that is configured to bypass the light's power supply when receiving current from the boat's electrical system (block 440).

While the invention has been described with respect to exemplary embodiments, one skilled in the art will recognize that numerous modifications are possible. For example, while the exemplary embodiments have been described with respect to a ski boat, one skilled in the art will appreciate that various embodiments can be used with a variety of other boats and water craft, such as recreational boats, houseboats, fishing boats, personal watercraft, and/or the like. Thus, although the invention has been described with respect to exemplary embodiments, it will be appreciated that the invention is intended to cover all modifications and equivalents within the scope of the following claims.

What is claimed is:

1. A nautical light for use on a skiboat, the nautical light comprising:
a light-emitting member disposed within a housing;
a body portion coupled with the housing;
a power supply in electrical communication with the light emitting member; and
a coupling member adapted to couple the body portion with a structural component of the skiboat.

2. A nautical light as recited in claim 1, wherein the power supply is disposed within the body portion.

3. A nautical light as recited in claim 1, wherein the structural component is a tow tower.

4. A nautical light as recited in claim 1, wherein the nautical light is configured to be coupled with the structural component of the skiboat so that the light emitting member casts light in an arc of the horizon in 360 degrees.

5. A nautical light as recited in claim 1, further comprising an extension member disposed between the housing and the body portion, the extension member being configured to provide additional distance between the light-emitting member and a water surface.

6. A nautical light as recited in claim 1, wherein the light-emitting member is further in electrical communication with an electrical system of the skiboat.

7. A nautical light as recited in claim 6, further comprising a bypass switch in electrical communication with the electrical system of the skiboat, the power supply and the light-emitting member, the bypass switch being configured to bypass the power supply when receiving an electrical current from the electrical system of the skiboat.

8. A nautical light as recited in claim 1, further comprising a light-sensing device in electrical communication with the light-emitting member, wherein the light-sensing device is configured to interrupt power to the light-emitting member when the light-sensing device senses light.

9. A nautical light as recited in claim 1, wherein the power supply comprises a plurality of batteries.

10. A nautical light as recited in claim 9, wherein the plurality of batteries comprises 4 AA-size batteries.

11. A nautical light for use on a skiboat, the nautical light comprising:
a light-emitting member disposed within a housing;
a body portion coupled with the housing;
an electrical connection configured to provide electrical communication between the light emitting member and an electrical system of the skiboat; and
a coupling member adapted to couple the body portion with a tow tower coupled to the skiboat, the coupling member being configured to allow the nautical light to be retrofitted on an existing tow tower without an existing nautical light.

12. A skiboat, comprising:
a tow tower; and
a nautical light comprising:
a light-emitting member disposed within a housing;
a body portion coupled with the housing;
a power supply disposed within the body portion, wherein the power supply is in electrical communication with the light emitting member; and
a coupling member adapted to couple the body portion with a structural component of the skiboat.

13. A tow tower for use on a skiboat, the tow tower having coupled therewith a nautical light comprising:
a light-emitting member disposed within a housing;
a body portion coupled with the housing;
a power supply disposed within the body portion, wherein the power supply is in electrical communication with the light emitting member; and
a coupling member adapted to couple the body portion with a structural component of the skiboat.

14. A method of using a nautical light, the method comprising:
providing a nautical light comprising:
a light-emitting member disposed within a housing;
a body portion coupled with the housing;
a power supply disposed within the body portion, wherein the power supply is in electrical communication with the light emitting member; and
a coupling member adapted to couple the body portion with a structural component of the skiboat; and
coupling the nautical light with a structural component of a skiboat.

15. A method as recited by claim 14, wherein the structural component is a tow tower.

16. A method as recited by claim 14, wherein the nautical light further comprises an electrical connection configured to provide electrical communication between the light emitting member and an electrical system of the skiboat, the method further comprising:
placing the electrical connection in electrical communication with the electrical system of the skiboat.

17. A method as recited by claim 16, further comprising:
receiving electrical current from the electrical system of the skiboat.

18. A method as recited by claim 17, further comprising:
bypassing the power supply of the nautical light and thereby powering the light-emitting member from the electrical system of the skiboat.

19. A method as recited by claim 14, wherein coupling the nautical light with a structural component of the skiboat comprises:
disposing the nautical light such that the light-emitting member casts light in an arc of the horizon in 360 degrees.

20. A method of retrofitting a skiboat, the method comprising:
providing a nautical light comprising:
a light-emitting member disposed within a housing;
a body portion coupled with the housing;
a coupling member adapted to couple the body portion with a tow tower coupled to the skiboat, the coupling member being configured to allow the nautical light to be retrofitted on an existing tow tower without an existing nautical light;
coupling the nautical light with the existing tow tower; and
disposing the nautical light such that the light-emitting member casts light in an arc of the horizon in 360 degrees.

21. A method as recited in claim 20, wherein the nautical light further comprises an electrical connection configured to provide electrical communication between the light emitting member and an electrical system of the skiboat, the method further comprising:
placing the electrical connection in electrical communication with the electrical system of the skiboat;
receiving electrical current from the electrical system of the skiboat; and
powering the light-emitting member with the electrical current received from the electrical system of the skiboat.

22. A method as recited in claim 20, wherein the nautical light further comprises a power supply disposed within the body portion, wherein the power supply is in electrical communication with the light emitting member, the method further comprising:
powering the light-emitting member with the power supply.
